(19) United States
(12) Patent Application Publication
(10) Pub. No.: US 2023/0001725 A1
(43) Pub. Date: Jan. 5, 2023

(54) METHOD AND MACHINE FOR PRODUCING RELIEFS AND PANEL COMPRISING SAID RELIEFS

(71) Applicant: Jesus Francisco BARBERAN LATORRE, Castelldefels (Barcelona) (ES)

(72) Inventor: Jesus Francisco BARBERAN LATORRE, Castelldefels (Barcelona) (ES)

(21) Appl. No.: 17/756,588

(22) PCT Filed: Feb. 1, 2021
(86) PCT No.: PCT/ES2021/070074

§ 371 Date: May 27, 2022

(30) Foreign Application Priority Data
Feb. 12, 2020 (EP) 20382098.0

(51) Int. Cl. B41M 3/06; B44C 3/02; B44C 5/04

(52) U.S. Cl. CPC B41M 3/06; B44C 3/025; B44C 5/04; B44F 9/02

(57) ABSTRACT

A method for producing a relief on a substrate, the relief having a recess area and a no-recess area, the recess area being adjacent to the no-recess area and forming a recess with respect to the no-recess area. The method extending a relief base layer on the substrate, digitally printing with a first volume per area of printed product on the outer surface of the extended relief base layer to obtain the recess area, the recess area forming the recess with respect to the outer surface of the extended relief base layer, and digitally printing with a second volume per area of printed product on the outer surface of the extended relief base layer at least adjacently to the recess area, to obtain the no-recess area.

### TECHNICAL FIELD

The present invention relates to a method for producing reliefs formed by recesses, cavities or depressions on a substrate, for example, in the form of embossing or textures. The invention also relates to a machine for producing said reliefs, as well as a panel containing said reliefs.

The invention is related to the panel manufacturing and decoration industry and, more specifically, panels for floors, walls, furniture, etc.

### STATE OF THE ART

The use of digital or inkjet technology for the production of reliefs formed by recesses on a substrate is currently widely known. The relief is obtained by digitally printing a digitised representation of the relief with a liquid printed product in the form of droplets that is deposited or injected onto a relief base layer that is extended on the substrate. Advantageously, digital printing makes it possible to obtain reliefs with a much greater definition, precision or sharpness compared to conventional production methods for reliefs formed by recesses on a substrate, such as embossing or moulding.

There are various known printing techniques for the digital printing of reliefs formed by recesses on a substrate. The present invention applies to any digital printing technique based on depositing or injecting a liquid recess printed product in the form of droplets onto the relief base layer. The recess printed product makes it possible to produce a recess in the relief base layer when deposited or injected thereon. Increasing the volume per area of recess printed product increases the depth of the recess to be formed with respect to the outer surface of the relief base layer.

In a first known digital printing technique of the type to which this present invention relates, a recess printed product is mixed with the relief base layer. The recess is obtained after removing the mixture of the printed product and the relief base layer, such that the recess corresponds to the volume of the mixture that was removed. Said mixture can be removed by mechanical means, such as brushing.

A known variant of this printing technique is based on using a relief base layer of UV-curable resin. Once the relief base layer is extended on the substrate, the liquid printed product is digitally printed on the liquid relief base layer, which has not been cured or is partially cured. The relief base layer is cured together with the mixed printed product. This printed product can be configured such that, after curing the relief base layer together with the printed product, removing the cured mixture with respect to the cured base layer becomes easier, for example, through mechanical means such as brushing. For example, a “trueTexture” jet ink, produced by Italian manufacturer ZEETREE, SRL, can be used to achieve this purpose.

Another known variant of this printing technique is based on using a solvent printed product on or that reacts chemically with the relief base layer. This technique is widely known in the field of electronic component manufacturing, which makes it possible to produce smaller recesses that are more suitable for microelectronic applications, as described, for example, in EP 1327259 B1.

A second widely known digital printing technique of the type to which the present invention relates is based on the simple deposit or injection of the recess printed product onto a liquid relief base layer, such that the relief is produced when the material of the relief base layer moves as a result of the impact of the droplets of printed product on the relief base layer. This digital recess printing technique is known as digital embossing. The recesses are obtained once the relief base layer solidifies, for example, by means of curing. Optionally, the printed product can be removed, for example, by evaporation. Depending on the volume of the droplets and their injection rate on the relief base layer, it is possible to obtain reliefs formed by recesses with different depths. This technique is described, for example, in patent document EP 3109056 A1.

The use of different substances for the recess printed product and the relief base layer, with properties that make it possible to obtain recesses with a greater definition or greater depth, for a certain volume and a certain rate for the injected droplets, is well known in this digital printing technique. For example, the use of substances with an appropriate surface energy or tension is known, as well as the use of repellent or immiscible agents between the printed product and the relief base layer, which make it possible to reduce or override the wettability of the printed product in the relief base layer. The use of repellent or immiscible agents in digital printing is well known, for example, from patent document JPH 10264346 A.

Unlike this second digital printing technique for recesses referred to as the digital embossing technique, in the first digital printing technique for recesses mentioned above, the recess obtained corresponds substantially to the material removed from the mixture between the printed product and the relief base layer, and the recess is not produced by the simple deposit or injection of the printing droplets onto the relief base layer and its subsequent solidification, but rather, in order to produce the recess, it is necessary to remove a mixture between the printed product and the relief base layer.

The drawback of this second digital embossing technique is that it only generates narrow, shallow and much less defined recess areas in the relief base layer compared to the first printing technique, in which there is no limit to the width of the recess.

There are other digital printing techniques for reliefs in the form of recesses based on the addition of material around the recess to be formed, in which the material corresponding to the recess is removed or displaced, unlike the printing techniques to which this invention relates. This technique is called 3D printing and is described, for example, in patent document EP 2507063 B1. The disadvantage of the 3D printing technique is that it provides limited mechanical resistance to the relief base layer, for example, to abrasion, in addition to its relatively high production costs.

Other digital printing techniques for recesses are also known where, unlike the printing techniques mentioned above, recesses are not produced through the removal or displacement of the material from the relief base layer or through the addition of material onto the substrate, but rather, the recesses are determined and achieved through the digital printing of the printed product on the relief base layer as described, for example, in patent document EP 2373494 B1. An example of these printing techniques is based on the digital printing of a mask against the UV curing of the relief base layer, such that the recess is achieved in the areas immediately below the mask, since a complete curing of the mask is not produced therein. Another example of these printing techniques is based on the digital printing of an agent that conditions the thermal expansion of the relief base layer in the areas where the recess is to be produced. These digital printing techniques for recesses have the disadvantage that the recesses that can be obtained are less defined than those produced with the type of digital printing technique for recesses to which the present invention relates.

The present invention aims to provide a method for producing reliefs formed by recesses with an improved definition, precision or sharpness and recess widths of any size and improved quality in terms of surface finish, avoiding edges that are sharp or rough to the touch.

### OBJECT OF THE INVENTION

In order to fulfil this objective and solve the technical problems discussed so far, in addition to providing additional advantages that will be described below, the present invention provides a method for producing a relief formed by recesses on a substrate. The relief comprises a recess area and a no-recess area. The recess area is adjacent to the no-recess area and forms a recess with respect to the no-recess area. The relief may comprise a plurality of recess areas and no-recess areas.

The method comprises the following steps:
extending a relief base layer on the substrate;
digitally printing with a first volume per area of liquid recess printed product in the form of droplets on the outer surface of the extended relief base layer to obtain the recess area, the recess area forming the recess with respect to the outer surface of the extended relief base layer,
digitally printing with a second volume per area of liquid recess printed product in the form of droplets on the outer surface of the extended relief base layer, at least adjacently to the recess area, to obtain the no-recess area.

In the context of the invention, relief can be understood, for example, as an embossing or a texture. Recess can be understood, for example, as a depression or cavity. The recess can have a variable recess depth with respect to the outer surface of the extended relief base layer.

Also, recess area should be understood as the surface formed by the recess in the relief base layer obtained from the digital printing with the first volume per area of recess printed product on the outer surface of the extended relief base layer. No-recess area should be understood as the surface obtained from the digital printing with the second volume per area of recess printed product on the outer surface of the relief base layer adjacent to the corresponding recess area. The no-recess area extends at least partially between recess areas and/or an edge of the relief base layer, in particular, at least 10%, preferably at least 50%, and more preferably, totally.

Depending on the second volume per area of the recess printed product for the no-recess area, the surface of the no-recess area obtained may be substantially smooth with respect to the recess of the adjacent recess area. The substantially smooth surface of the no-recess area should also be understood as a matte surface and/or with a substantially reduced surface roughness with respect to a maximum recess depth of the recess in the recess area, i.e., in particular, a surface roughness less than or equal to 10% of said maximum recess depth, preferably 5%, and even more preferably, 1%.

Surprisingly, it has been found that, when printing with droplets of the printed product in the no-recess area adjacent to the recess area, it is possible to increase the definition or sharpness of the recess area. Printed droplets are confined by adjacent printed droplets. This way, by depositing or injecting the printed product onto both the recess area and the no-recess area and not only onto the recess area, the printed product from the recess area can be confined, possibly preventing or reducing coalescence among the droplets of the first volume per area and of the second volume per area of printed product that are deposited or injected onto the adjacent relief base layer.

An embodiment according to the invention envisages that the recess printed product is mixed with the relief base layer to form the recess area. In this case, the method comprises removing a mixture of the printed product and the relief base layer, such that the recess of the recess area corresponds to the volume occupied by the mixture that was removed in the relief base layer. The mixture can be removed, for example, by mechanical means, such as brushing, suction, blowing, blasting with pressurised material (water, sand or any other abrasive element), by evaporation means, e.g., with hot air or IR radiation, or by chemical means.

Another embodiment according to the invention envisages that the recess printed product is deposited or injected onto the liquid relief base layer using the digital embossing printing technique. According to this embodiment, the volume per area of printed product, in particular droplet volume, and/or the droplet injection rate, can be modified to obtain different recess depths.

Preferably, the digital printing according to the invention is performed on the liquid relief base layer. This also facilitates mixing the liquid printed product and the relief base layer. In this vein, the invention envisages that the relief base layer is solidified, fixed and/or cured during and/or after the digital printing (with the first volume per area and/or with the second volume per area of printed product). The relief base layer can be solidified, fixed and/or cured, e.g., by heat, electromagnetic radiation and/or light, in particular, UV or IR.

Preferably, the relief base layer is cured, especially through UV curing. The liquid relief base layer may not be cured or be partially cured during the digital printing, in particular, also with the first volume per area and/or with the second volume per area of printed product. In this context, the term curing includes the concept of polymerisation.

Curing resins, such as radical, acrylic or polyurethane resins, as well as mixtures thereof, can be used in the curing of the liquid relief base layer. Curing monomers or oligomers, as well as mixtures thereof, can be used as recess printed products mixed with the liquid base layer.

The printed product for the first volume per area can be made of the same or of a different material than the printed product for the second volume per area. It is also envisaged that different printed product materials for different points on the relief base layer can be used during printing.

Said printed product can be configured such that, after curing the relief base layer together with the printed product, removing the cured mixture with respect to the cured base layer to form the relief, and in particular, the recess area, becomes easier. In particular, the printed product may be configured to provide incomplete curing or curing inhibition of the mixture between the printed product and the base layer.

Alternatively, the relief base layer can be solid, in particular, porous, to facilitate the mixture of the printed product with the relief base layer. In this case, a solvent of the relief base layer, for example, can be used as printed product.

The digital printing with the second volume per area of printed product can be performed simultaneously, before or after the digital printing with the first volume per area. Preferably, it is performed simultaneously, more preferably, before, such that the confinement of the droplets of the first volume of printed product can be favoured by means of the droplets of the second volume of printed product. The order of magnitude of the digital printing injection and feed times is considered to be much lower than the dispersion or penetration times of the droplets of printed product in the relief base layer, especially for single pass digital printing, which provides equally effective results regardless of the moment when the printing is performed with the first volume and with the second volume. In this vein, however, more preferably said digital printing can be performed immediately and in a consecutive manner.

The digital printing with the second volume per area is also envisaged as being performed on the extended relief base layer on which the digital printing is performed with the first volume per area, i.e., not only on a no-recess area of the outer surface of said extended relief base layer. Advantageously, depth gradients in the contours of the recess area can be smoothed over while improving the definition of the recess areas and the quality of the textures, since the printed product can be injected along the entire relief base layer in a uniform manner for the recess area and for the no-recess area.

In relation to the quantity of the second volume per area of printed product that is injected, it should be large enough to produce an effect of improving the definition of the confinement recess area of the first volume per area of printed product, and small enough not to produce excessive recesses or wear, or perforate the relief base layer. In this vein, a second volume per area is preferably greater than or equal to 5% of a maximum first volume per area in the recess area, more preferably to 30%, even more preferably to 50%. Also, a second volume per area is preferably less than or equal to said maximum first volume per area, more preferably to 70%, even more preferably to 50%, of said maximum first volume per area.

In relation to droplet volume (in particular, droplet level or droplet size), it is envisaged that, preferably a droplet volume for the second volume per area is less than or equal to 70% of a maximum droplet volume for the first volume per area, more preferably less than or equal to 50%, even more preferably to 30%. Advantageously, this decreases the volume of printed product in the adjacent no-recess area without affecting the confinement effect of the droplets of the first volume of printed product in the recess area.

In addition, the second volume per area and, optionally, the droplet volume for that second volume per area, is also envisaged to be uniform along the relief base layer, i.e., for the no-recess area and/or for the recess area. This results in a uniform finish in the no-recess area. The first volume per area is also envisaged to be uniform along the relief base layer, corresponding to a constant depth of the recess area.

In relation to the matting or surface finish of the no-recess area produced by the second volume per area of printed product, preferably, the second volume per area and, optionally, the droplet volume for said second volume per area, is such that it produces a surface roughness of the relief base layer in the no-recess area less than or equal to 20 microns, more preferably to 10 microns, even more preferably to 5 microns, and/or, preferably, it produces a brightness at 60° greater than or equal to 10 GU, more preferably to 20 GU, even more preferably to 50 GU. These values of surface roughness and brightness at 60° are considered, in particular, to be measured immediately after the mixture is removed.

It is also envisaged that the relief is made in register with an image printed on the substrate, visible through the relief base layer. To achieve this, the relief base layer can be transparent or translucent.

The extension of the relief base layer on the substrate can be done, for example, by means of a roller, in particular by means of a reverse roller, or in a conventional way. The extension of the relief base layer by means of a roller makes it possible to obtain a large thickness of the relief base layer, corresponding to large weights. Therefore, it is possible to provide recesses with a corresponding depth.

Preferably, the relief base layer extended on the substrate has a thickness greater than or equal to 20 microns, more preferably to 30 microns, even more preferably to 50 microns and/or, preferably, less than or equal to 300 microns, more preferably to 200 microns, even more preferably to 100 microns.

This way, for example, according to the invention, it is possible to obtain reliefs with a depth of up to 100-300 microns, for the recess area. In addition, the greater recess depths that can be obtained make it possible to provide an effect of achieving a better definition of the corresponding recess areas, with surface roughness of the no-recess area from, for example, 1-5 microns to 10-20 microns.

According to the invention, it is also envisaged that the method comprises digitising a relief representation, which defines the recess area and the no-recess area, the recess area, for example, with a recess depth value associated with the depth of the recess area (i.e., with respect to the outer surface of the relief base layer once extended, on which the digital printing takes place to form the recess area), per point of the relief representation. In particular, it is possible to assign a variable volume per area of printed product per point of the relief representation to obtain, for example, a recess with a variable depth in the recess area. In the context of the invention, the term point of the relief representation comprises the concept of pixel.

With respect to the relief representation, it is envisaged that this may be, in particular, a relief image. A relief image can be, for example, a black-and-white or grayscale image, such that a no-recess area is defined as white, a recess area with a maximum recess depth value is defined as black, and a recess area with recess depth values that are less than said maximum recess depth value is grey with a variable colour scheme ranging from white to black as the recess depth value increases.

According to another aspect, the invention relates to a machine for producing a relief on a substrate comprising a computer system that stores a computer program configured to carry out a method as described above when the computer program is run by the computer system.

According to another additional aspect, the invention also relates to a panel comprising a substrate with a relief on the substrate, wherein the relief is produced according to a method or a machine as described above. The relief can be extended on the entire front surface of the panel.

### DESCRIPTION OF THE FIGURES

Advantages, features and additional application possibilities of the present invention are obtained from the following description in relation to the exemplary embodiments represented in the drawings.

The invention is explained in more detail below by way of an example and in reference to the attached drawings. The drawings show:

FIG. 1 shows a schematic view of an embodiment of a method for producing reliefs on substrates, as well as a production machine for carrying out such method.

FIG. 2 shows a schematic view of an embodiment of a panel with a relief on a substrate, which is obtained according to the embodiment of FIG. 1.

FIGS. 3a and 3b schematically show an interpretation of the operations of the invention.

FIG. 4 shows a relief representation used in an exemplary embodiment of the invention.

FIG. 5 shows relief representations processed from the relief representation in FIG. 4 for the exemplary embodiment.

FIG. 6 shows photographs of relief samples obtained according to the exemplary embodiment.

FIGS. 7 to 10 show detailed photographs of reliefs obtained according to the exemplary embodiment.

### DETAILED DESCRIPTION OF THE INVENTION

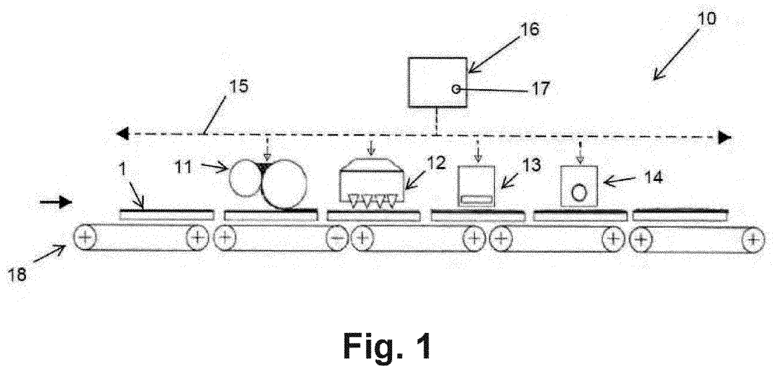

FIG. 1 schematically represents an embodiment of the method for producing a relief (20) on a substrate (3) to form a panel (1), as well as a machine (10) for carrying out said method according to the invention.

As shown in FIG. 1, the method comprises digitising a relief representation (30), which is carried out through a computer system (16). The computer system (16) stores a computer program (17) configured to carry out the method by running the computer program (17). The digitisation of a relief representation (30) is carried out, in particular, by receiving, recording, processing, generating, etc. the relief representation (30) and/or relief representations processed in the computer system (16).

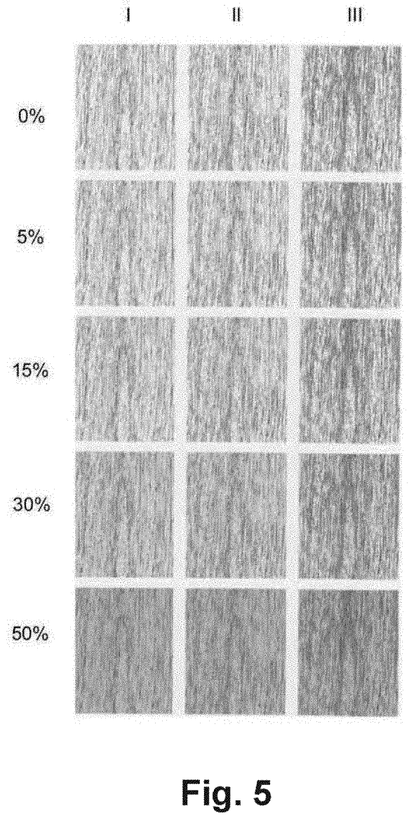

A relief representation (30) defines the recess area (21) and the no-recess area (22) of the relief (20) to be produced, i.e., by delimiting those areas and assigning a recess depth value in the recess area (21) with respect to the no-recess area (22). An example of relief representation (30) is the image shown in FIG. 4, wherein the recess area (21) is defined as black, while the no-recess area (22) is defined as white. In this case, the depth value of the recess area (21) is constant.

The method comprises extending a relief base layer (2) by means of a roller application unit (11) of the liquid material of the relief base layer (2). Then, using a digital printer (12), digital printing is performed on the relief base layer (2) with a first volume per area (41) of liquid printed product in the form of droplets per point of the relief representation (30). Also, in this case with the same digital printer (12), digital printing is performed with a second volume per area (42) of liquid printed product in the form of droplets per point of the relief representation (30). The digital printing comprises depositing or injecting the liquid printed product onto the relief base layer (2).

According to a variant of the embodiment described above, digital printing with the second volume per area (42) of printed product is performed on the entire outer surface of the relief base layer (2), i.e., for both the recess area (21) and the no-recess area (22). However, it is also envisaged that digital printing with the second volume of printed product can be performed only in a no-recess area (22) adjacent to or joined to the recess area (21), for example, arranged surrounding, bordering, around or in a contour of the recess area (21), in particular, in at least one contour subarea of the recess area (21). In contrast, the digital printing with the first volume per area (41) of the printed product is performed for the recess area (21), and said volume may be variable according to the depth value of the recess to be obtained.

The printed product deposited or injected onto the relief base layer (2) is mixed with the material of the relief base layer (2), penetrating the relief base layer (2). In this embodiment described above, the relief base layer (2) is made of a UV-curing resin material, while the injectable printed product to be mixed with the relief base layer (2) is configured to facilitate, after curing the relief base layer (2) together with the printed product, the removal of the cured mixture (40) with respect to the cured relief base layer (2) to form the relief, in particular, the recess area (21). When curing the printed product together with the relief base layer (2), an easily removable mixture(40) with respect to the material of the unmixed relief base layer (2) is produced.

Following the description of the embodiment as shown in FIG. 1, after the digital printing, the relief base layer (2) is cured with the application of UV radiation on the relief base layer (2) together with the printed product mixed therein. This application of UV radiation is carried out by a UV curing unit (13).

As shown in FIG. 1, the mixture (40) of the printed product and the relief base layer (2) are removed after the curing, such that the recess area (21) obtained corresponds to the volume occupied by the mixture (40) that was removed in the relief base layer (2), i.e., the volume on the recess area (21). The mixture (40) can be removed, for example, with a brushing unit (14) on the outer surface of the relief base layer (2).

In the embodiment described above, the substrate (3) or panel (1) on which the relief (20) is extended is displaced by a transport unit (18), for example, a conveyor belt, as it moves forward through the successive stations of the method described above.

The computer system (16) carries out the method by actuating the different units of the production machine (10) through a data communication (15) between the computer system (16) and the different units (11, 12, 13, 14).

With respect to the form of the substrate (3) to which the method is applied according to the invention, it is preferably provided as a panel (1); however, there is no limitation in the application of the production method of the invention to any form of substrate (3), for example, panel profiles (1). Also, preferably, the outer surface of the extended relief base layer (2) is envisaged to be substantially flat, such that the no-recess area (22) is substantially flat; however, there is also no limitation as to the surface on which the reliefs (20) formed by recesses according to the invention can be curved, for example, undulating, or have any other shape, such as being provided with protrusions, bumps or recesses, depressions or cavities on which the recesses according to the invention can be obtained.

Any material can be used as material for the substrate (3). For example, the application to panels (1) made of wood materials or derivatives, such as solid wood, agglomerate wood, HDF, MDF or plywood, is envisaged. The use of synthetic materials, for example, is also envisaged, especially for synthetic floors, MMLF (“Multi-Layer Modular Floor”). Examples of application of synthetic materials include LVT (“Luxury Vinyl Tiles”), SPC (“Stone Plastic Composites”), WPC (“Wood Plastic Composite”), or PE or PVC panels (1) or profiles, etc. Other applications of materials envisaged include fibre cement, aluminium or steel panels (1) or profiles, etc.

Returning to the description of the production method, it also envisages including other steps or stations of the corresponding production machine (10) as explained below, also for a preferred embodiment wherein the substrate (3) is a panel (1).

Beginning with the substrate (3), once the outer surface thereof has been prepared and cleaned, a first primer layer that may be cured can be applied on the substrate (3). This primer layer facilitates the application of an image base layer, which is applied on the primer layer and may also be cured. An image that is digitally printed with visible ink, which can also be cured, is applied on the image base layer. A protection layer of the printed image, which can also be cured, can subsequently be applied. The curing can be carried out through UV-curing.

The relief base layer (2) can be applied on this assembly of layers, as well as the subsequent steps of the method according to the invention described above. Once the mixture (40) of printed product and the relief base layer (2) have been removed, a surface finish layer can be applied on the assembly, which may also be cured, for example through UV curing.

The layers on the image base layer with the printed image, in particular, the relief base layer (2), can be transparent or translucent, such that the image can be seen on the substrate (3) from the top of the relief (20). The relief (20) and the printed image can be carried out in sync, i.e., in register with each other, such that, for example, a design effect can be provided wherein the relief (20) and the image are associated or linked to each other, for example, by overlapping when seen from the top of the substrate (3). In particular, it is thus possible to simulate a real design such as a wood texture. The image can comprise a pattern, a colour, a shape, and so on. Alternatively or in addition, it is also envisaged that a printed image can be made on the relief (20), in particular, in sync, i.e., in register between the image and the relief (20).

With respect to the first volume per area (41) of printed product and the second volume per area (42) of printed product, it may vary depending on, for example, the level, volume or size of the injection droplet, the number of injection points per area or printer resolution (e.g., measured in dpi, meaning dots per inch). The higher the volume of printed product injected at each print point, the greater the depth of its penetration within the relief base layer (2) in which the drop are injected, and therefore, the greater the depth of the recesses.

In this vein, a parameter associated with the volume per area of printed product that can be injected onto the relief base layer (2) can be defined, added to a digital printing method and/or a digital printer (12) for obtaining reliefs (20). A value of 100% is assigned to the maximum volume per area of printed product that can be obtained by means of a certain method and/or digital printer (12). An input percentage of 0% indicates that no printed product is applied. The higher the input percentage or the volume per area of printed product, the greater the recess depth that can be obtained.

Preferably, the input percentage corresponding the second volume per area (42) of printed product is relatively low compared to the input percentage corresponding to the first volume per area (41) of printed product. This way, the no-recess area (22) is not substantially recessed, perforated or worn, while providing a recess area (21) with an improved definition and therefore, reliefs (20) of a very high quality.

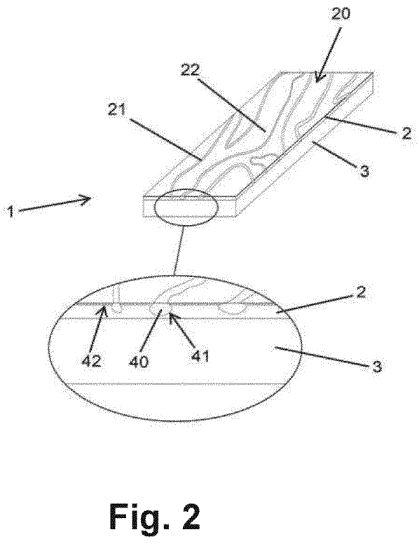

FIG. 2 shows a substrate (3) in the form of a panel (1). A relief (20) formed by recesses in a relief base layer (2) is applied on the substrate (3) The relief (20) is formed by recess areas (21) and no-recess areas (22). For the purposes of clarity, the figure shows the substrate (3) with the mixture (40) of the material of the relief base layer (2) and printed product in the relief base layer (2), before the mixture (40) is removed to obtain the recesses corresponding to the volume occupied by the mixture (40). Both droplets of the first volume per area (41) of printed product (for recess areas (21)) and droplets of the second volume per area (42) of printed product (for no-recess areas (22)) have been deposited on the relief base layer (2).

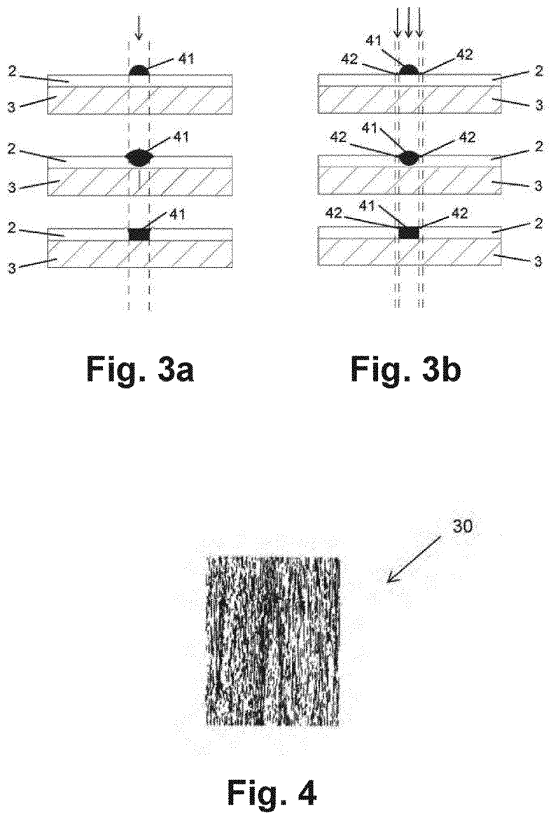

FIGS. 3a and 3b seek to represent an interpretation of the operating principle of the invention (FIG. 3b) compared to the state of the art (FIG. 3a). By injecting the printed product for the entire relief (20) and not only for the recess areas, it is possible to confine, hold or anchor the mixture (40) formed in the relief base layer (2), possibly preventing or reducing coalescence among the droplets of the first volume per area (41) and of the second volume per area (42) of printed product that are deposited or injected onto the relief base layer (2). When the droplets of printed product are not injected onto the area adjacent to the recess area (21) (FIG. 3a), the printed product can expand into its surroundings in a greater and more uncontrolled basis than if the printed product were injected adjacent to or around it in order to favour confinement.

### Exemplary Embodiment

The digital printing of the printed product was performed with a single pass digital printer (12) with two print heads, at a resolution of 360 dpi and three droplet levels (injected droplet volume): 14 pl, 28 pl and 43 pl.

The “trueTexture” jet ink, made by Italian manufacturer ZEETREE, SRL, was used as printed product.

The volume per area of printed product can vary, for example, by selecting the number of nozzles of the digital printer (12) per area, the droplet level per nozzle, as well as the number of passes or number of print heads per single pass digital printer (12) to deposit the printed product on the relief base layer (2).

In this exemplary embodiment, one pass was carried out with said digital printer (12). The printing was performed at a speed of 25 m/min on a 1000×200×4 mm SPC (“Stone Plastic Composite”) substrate (3) (common dimensions for floor slats).

The maximum volume per area of printed product for the exemplary embodiment corresponds to an injection with a maximum resolution of 360 dpi×360 dpi and a maximum droplet level of 43 pl in a single pass with the two print heads, i.e., a volume per area of printed product of 17.276 ml/m2. This maximum volume per area of printed product corresponds to the input percentage of 100%.

The input percentage of printed product for the digital printing varies between 0% and 100%, such that the higher the input percentage, the greater the depth of its penetration within the relief base layer (2) onto which the printed product is injected and therefore the depth of the recess obtained.

A UV-curing resin, which can be obtained from the manufacturer KLUMPP under reference 161-000-00430 (“UV Sealer”), was used as a material for the relief base layer (2). The resin was extended on the substrate (3) by means of a roller, with a thickness of the relief base layer (2) of approximately 100 microns, corresponding to a weight of approximately 100 gr/m2.

The image shown in FIG. 4, wherein the recess area (21) is defined as black and the no-recess area (22) is defined as white, was used as an example of a relief representation (30). According to this relief representation (30), the recess depth value for the recess area (21) is constant.

According to this relief representation (30), for the recess area (21) the relief base layer (2) was printed uniformly with a constant first volume per area (41) of printed product, corresponding to the 100% input percentage. Also, for the no-recess area (22), the relief base layer (2) was printed uniformly with a constant second volume per area (42) of printed product, which is less than the first volume per area (41) of printed product. In this exemplary embodiment, the second volume per area (42) of printed product was extended along the entire relief base layer (2) for the no-recess area (22).

For this relief representation (30), different samples were obtained by varying the second volume per area (42) of printed product, respectively, for different input percentages: 5% (0.864 ml/m2), 15% (2.591 ml/m2), 30% (5.183 ml/m2) and 50% (8.638 ml/m2).

In addition, the relief representation (30) of FIG. 4, corresponding to a fine stroke texture (I), was modified by gradually increasing the width of the strokes of the texture to obtain a relief representation (30) corresponding to a medium stroke texture (II) and a thick stroke texture (III).

In addition, for the fine stroke (I) relief representation (30), the medium stroke (II) relief representation (30) and the thick stroke (III) relief representation, different samples were also obtained by varying the second volume per area (42) of printed product, respectively, for different input percentages, 5% (0.864 ml/m2), 15% (2.591 ml/m2), 30% (5.183 ml/m2) and 50% (8.638 ml/m2).

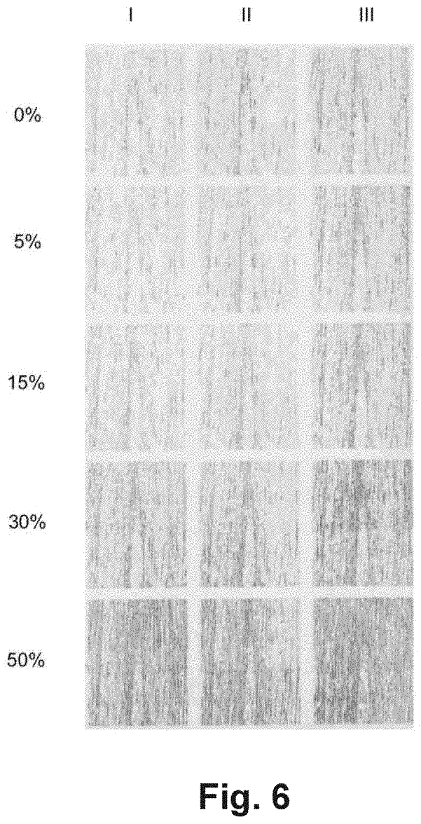

The processed relief representations of FIG. 5 were generated for the digital printing of the recess areas (21) and the no-recess areas (22) with the corresponding input percentages for the respective fine stroke (I), medium stroke (II) and thick stroke (III) relief representations (30). These processed relief representations are images that define the input percentage of printed product using a grayscale ranging between white, which corresponds to a 0% input, and black, which corresponds to a 100% input.

The processed relief representations are shown in FIG. 5 arranged in an array, where the rows correspond to the input percentage corresponding to the second volume per area (42) of printed product, for 0%, where nothing is printed on the no-recess areas (22) (adjacent to the recess areas), 5%, 15%, 30% and 50%. The columns of the array correspond to the width of the recess areas, in the example of the strokes forming the relief (20), that is, fine (I), medium (II) and thick (III) widths.

The processed relief representations are processed by a computer program (17) of the computer system (16) for the digital printer (12) to determine the injection, the volume per area of printed product, the number of droplets per area, the droplet level, etc.

Samples with the printed product deposited or injected onto the relief base layer (2) were cured by means of UV lamps applying a total energy of 200 mJ/cm2, with a wavelength of between 230-410 nm and a peak power of 600 mW/cm2 to initiate the curing reaction.

After curing the samples, the mixture (40) between the printed product and the relief base layer (2) was removed by brushing, thus obtaining the reliefs (20) or textures formed by recesses corresponding to the recess areas.

The results obtained from the samples are described below.

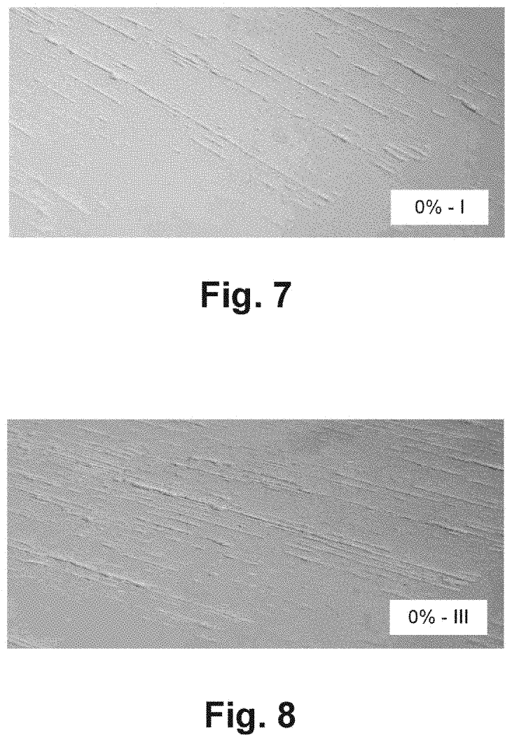

FIG. 6 shows photographs of the samples provided, which correspond to the processed relief representations in FIG. 5. After obtaining the relief (20), a black powder filling pigment was applied on the recesses in order to appreciate the same in the photographs, the relief base layer (2) being transparent and applied on a substrate (3) with a white surface.

As shown in the photographs in FIG. 6, if only the recess area (21) is printed, that is, for 0% input in the no-recess area (22), the relief (20) is barely noticeable and poorly defined for a fine texture (I), i.e. a narrow stroke. On the other hand, for thick textures (III) with wider strokes, the relief (20) is uneven, rough to the touch and with sharp edges.

Surprisingly, when the background or no-recess area (22) is injected with an increasing input percentage of up to 50%, it is possible to obtain a better definition of the relief (20), as well as a smooth or progressive transition between the recess area (21) and the no-recess area (22), resulting in a greater quality for the relief (20) or texture. Thus, for example, a relief (20) with a 50% input and a fine stroke (I) is well defined and visible compared to a relief (20) with a 0% input and a fine stroke (I) where the relief (20) is barely appreciated. On the other hand, a relief (20) with a 50% input and a thick stroke (III) is much more defined and not rough to the touch, unlike the relief (20) with a 0% input and a thick stroke (III).

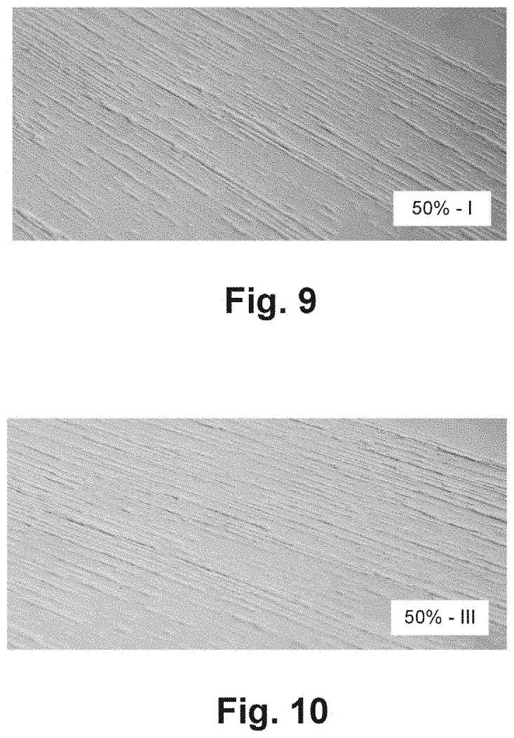

FIGS. 7 to 10 show photographs showing the reliefs (20) with contrast and in detail, without the black pigment of FIG. 6. FIG. 7 shows the relief (20) with a 0% input and a fine stroke (I). FIG. 8 shows the relief (20) with a 0% input and a thick stroke (III). FIG. 9 shows the relief (20) with a 50% input and a fine stroke (I). FIG. 10 shows the relief (20) with a 50% input and a thick stroke (III).

In short, it has been found that, if the areas adjacent to the recess areas are printed as well as the recess areas where the recess is to be generated, the textures are more defined and appreciable for the fine strokes, i.e., narrower strokes, in the recess areas. Even if the thickness were to be increased, for example, to further improve the definition of the reliefs (20), then smoother reliefs (20) are obtained.

It has also been found that injecting printed product onto the relief base layer (2) up to a maximum input percentage, for example, 50%, after curing and removing the mixture (40) produced, generates recesses that are barely noticeable to the touch or that cannot be seen in plain sight, even if a certain matting can be observed.

As has been explained above, it is possible to achieve a more precise and defined relief (20), texture or embossing of a greater quality by means of the present invention.

### LIST OF REFERENCES

1 Panel
2 Relief base layer
3 Substrate
10 Relief production machine
11 Roller application unit
12 Digital printer
13 Curing unit
14 Brushing unit
15 Data communication
16 Computer system
17 Computer program
18 Transport unit
20 Relief
21 Recess area
22 No-recess area
30 Relief representation
40 Mixture
41 First volume of printed product
42 Second volume of printed product
I Fine texture
II Medium texture
Ill Thick texture

1. A method for producing a relief on a substrate, the relief comprising a recess area and a no-recess area, the recess area being adjacent to the no-recess area and forming a recess with respect to the no-recess area, comprising:
extending a relief base layer on the substrate,
digitally printing with a first volume per area of liquid recess printing product in the form of droplets on the outer surface of the extended relief base layer to obtain the recess area, the recess area forming the recess with respect to the outer surface of the extended relief base layer,
digitally printing with a second volume per area of liquid recess printed product in the form of droplets on the outer surface of the extended relief base layer, at least adjacently to the recess area, to obtain the no-recess area.

2. The method for producing a relief on a substrate according to claim 1, further comprising removing a mixture of printed product and relief base layer, such that the recess corresponds to the volume occupied by the mixture removed in the relief base layer.

3. The method for producing a relief on a substrate according to claim 1, wherein the recess is obtained by digital embossing.

4. The method for producing a relief on a substrate according to claim 1, wherein the digital printing is performed on the liquid relief base layer.

5. The method for producing a relief on a substrate according to claim 1, wherein the relief base layer is cured together with the printed product.

6. The method for producing a relief on a substrate according to claim 1, wherein the digital printing with the second volume per area is performed simultaneously or before the digital printing with the first volume per area.

7. The method for producing a relief on a substrate according to claim 1, wherein the digital printing with the second volume per area is also performed on the extended relief base layer on which the digital printing is performed with the first volume per area.

8. The method for producing a relief on a substrate according to claim 1, wherein the second volume per area is greater than or equal to 5% of a maximum first volume per area for the recess area, and/or less than or equal to said maximum first volume per area of said maximum first volume per area.

9. The method for producing a relief on a substrate according to claim 1 wherein a droplet volume for the second volume per area is less than or equal to 70% of a maximum droplet volume for the first volume per area.

10. The method for producing a relief on a substrate according to claim 1, wherein the second volume per area and, optionally, the droplet volume for said second volume per area, is uniform along the relief base layer.

11. The method for producing a relief on a substrate according to claim 1, wherein the no-recess area obtained has a superficial roughness less than or equal to 20 microns, and/or a brightness at 60° greater than or equal to 10 GU measured.

12. The method for producing a relief on a substrate according to claim 1, wherein the relief is made in register with an image printed on the substrate, visible through the relief base layer.

13. The method for producing a relief on a substrate according to claim 1, wherein the extended relief base layer has a thickness greater than or equal to 20 microns, and/or less than or equal to 300 microns.

14. A machine for producing a relief on a substrate, further comprising a computer system that stores a computer program configured to carry out the method according to claim 1 when the computer program is run by the computer system.

15. A panel comprising a substrate with a relief on the substrate, wherein the relief is produced according to the method according to claim 1.

16. The method for producing a relief on a substrate according to claim 8, wherein the second volume per area is greater than or equal to 30% of the maximum first volume per area for the recess area, and/or less than or equal to 70% of said maximum first volume per area.

17. The method for producing a relief on a substrate according to claim 9, wherein the droplet volume for the second volume per area is less than or equal to 50% of the maximum droplet volume for the first volume per area.

18. The method for producing a relief on a substrate according to claim 11, wherein the no-recess area obtained has a superficial roughness less than or equal to 10 microns, and/or a brightness at 60° greater than or equal to 20 GU measured.

19. The method for producing a relief on a substrate according to claim 13, wherein the thickness is greater than or equal to 30 microns, and/or less than or equal to 200 microns.
